(19) United States
(12) Patent Application Publication
(10) Pub. No.: US 2009/0215614 A1
(43) Pub. Date: Aug. 27, 2009

(54) Colloidal dispersions of compounds of cerium and at least one of zirconium, rare earths, titanium and/or tin and preparation/applications thereof

(75) Inventor: Jean Yves Chane-Ching, Lacroix Salgarde (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, AUBERVILLIERS CEDEX (FR)

(21) Appl. No.: 11/918,885

(22) PCT Filed: Apr. 18, 2006
(86) PCT No.: PCT/FR2006/000847

§ 371 Date: Jan. 16, 2009

(30) Foreign Application Priority Data
Apr. 20, 2005 (FR) 0503951

(51) Int. Cl. B01J 23/10; C04B 14/00; C09K 3/00

(52) U.S. Cl. 502/304; 106/450; 252/380

(57) ABSTRACT

Colloidal dispersions, in a continuous phase, contain a compound of cerium and another element M selected from among zirconium, rare earths (Ln) other than cerium, titanium and tin, wherein such compound is in the form of a mixed oxide in which the cerium and the element M are in solid solution; the cerium is in the form of cerium III in an amount expressed in cerium III/total cerium atomic ratio ranging between 0.005 and 0.06 and the dispersion is produced by forming a liquid medium comprising cerium salts, in particular of cerium III, and the element M, contacting the medium with a base to provide a pH of not less than 9, separating and washing the resulting precipitate and peptizing same by treating with an acid whereby the dispersion is obtained.

The present invention relates to a colloidal dispersion of a compound of cerium and of at least one other element M chosen from zirconium, rare earth metals, titanium and tin, to a dispersible solid based on the same compound and to their process of preparation.

Compounds based on an oxide of cerium and of another element, such as zirconium or a rare earth metal, are of great interest. Due to their high oxygen storage capacity and their thermal stability, they can be used in the field of catalysis. They can also be employed as agent for protecting against ultraviolet rays or as pigments.

Furthermore, there exists a strong demand industrially for compounds of this type in the form of nanoparticles and more particularly in the form of colloidal dispersions. In point of fact, the preparation of dispersions of such compounds is not easy and requires relatively complex processes. Furthermore, the known processes do not make it possible to obtain dispersions of compounds in a highly crystalline form, in particular at least partially in the form of solid solutions. In point of fact, in some applications, very particularly in the field of catalysis, a search is on the way for products existing in the form of solid solutions, these solid solutions conferring improved properties. There is thus a need for such dispersions of solid solutions.

The object of the invention is thus to provide these colloidal dispersions and a process giving access thereto.

With this aim, the dispersion of the invention is a colloidal dispersion, in a continuous phase, of a compound of cerium and at least one other element M chosen from zirconium, rare earth metals (Ln) other than cerium, titanium and tin and it is characterized in that the compound is in the form of a mixed oxide in which the cerium and the element M are in pure solid solution and in that the compound comprises cerium in the form of cerium(III) in an amount, expressed as cerium(III)/total cerium atomic ratio, of between 0.005 and 0.06.

Furthermore, the invention also relates to a process for the preparation of the above dispersion which comprises the following stages:
a liquid medium comprising salts of cerium and of at least one element M is formed, the cerium salts being cerium(IV) and cerium(III) salts;
the medium is brought into contact with a base, so as to obtain a pH of at least 9, whereby a precipitate is obtained;
said precipitate is separated from the medium;
the precipitate is washed;
the precipitate is peptized by treatment with an acid, whereby the dispersion is obtained; the process additionally comprising at least one washing stage, either after the stage of separating of the precipitate or after the peptization stage.

The above process comprises a relatively low number of stages and makes it possible to directly arrive at the desired dispersion by simple chemical operations, this being the case for a broad range of dispersions as regards the nature of the elements of the mixed oxide.

Other characteristics, details and advantages of the invention will become even more fully apparent on reading the description which will follow, and also the various concrete but nonlimiting examples intended to illustrate it and the appended drawings, in which:

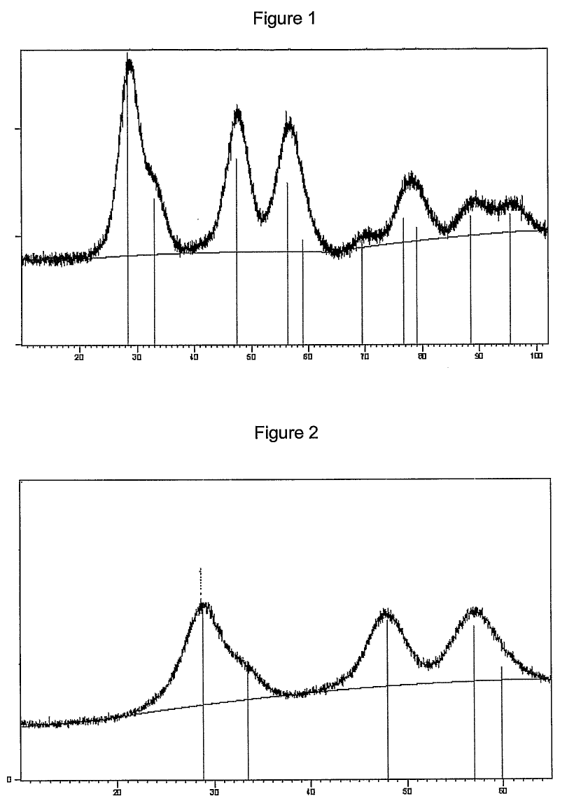

FIG. 1 is an X-ray diagram of a compound based on cerium and of titanium resulting from a dispersion according to the invention;

FIG. 2 is an X-ray diagram of a compound based on cerium and on zirconium resulting from a dispersion according to the invention.

For the continuation of the description, the expression “colloidal dispersion or sol of a compound of cerium and of another element M” denotes any system composed of fine solid particles of colloidal dimensions of this compound, that is to say particles having a size generally situated between 1 nm and 100 nm, more particularly between 2 nm and 50 nm. These particles are based on an oxide of cerium and of the other element M, in suspension in a liquid continuous phase, said particles comprising, as counterions, bonded or adsorbed ions, such as, for example, acetates, nitrates, chlorides or ammoniums. It should be noted that, in such dispersions, the cerium and the other element M can be found either completely in the form of colloids or simultaneously in the form of ions or polyions and in the form of colloids.

The liquid continuous phase is generally, in the case of the present invention, an aqueous phase, more particularly water.

Furthermore, and still in the context of the present description, the term “rare earth metal” is understood to mean the elements from the group consisting of yttrium and the elements of the Periodic Table with an atomic number of between 57 and 71 inclusive. The term “trivalent rare earth metal” is understood to mean, unless otherwise indicated, a rare earth metal which can only exist in the trivalent form.

Finally, it is specified that, unless otherwise indicated, in the ranges of values which are given, the values at the limits are included.

One of the specific characteristics of the dispersion of the invention is that the abovementioned compound is in the form of a mixed oxide (Ce,M)O₂ in which the cerium and the element M are in solid solution. This is understood to mean that one of the elements, generally the element M, is completely incorporated in the crystal lattice of the oxide and the other matrix-forming element, for example cerium. This incorporation can be demonstrated by the X-ray diffraction technique on colloids after washing, in particular by ultra-filtration or also by ultracentrifuging, and drying at a temperature of 60° C. The X-ray diagrams reveal the presence of a crystalline structure corresponding to the oxide of the matrix-forming element (generally cerium oxide) and having unit cell parameters more or less offset with respect to a pure oxide of this first matrix-forming element, which thus demonstrates the incorporation of the other element in the crystal lattice of the oxide of the first. For example, in the case of a solid solution of the element M in cerium oxide, the X-ray diagrams then reveal a crystalline structure of fluorite type, just like crystalline ceric oxide CeO₂, the unit cell parameters of which are more or less offset with respect to a pure ceric oxide, thus reflecting the incorporation of the element M in the crystal lattice of the cerium oxide.

The solid solution is pure, that is to say that the total amount of one element is in solid solution in the other, for example all the element M in solid solution in the cerium oxide. In this case, the X-ray diagrams show only the presence of the solid solution and do not comprise lines corresponding to an oxide of the type of oxide of the element other than the matrix-forming element, for example an oxide of the element M.

As indicated above, the element M is chosen from the group consisting of zirconium, rare earth metals (Ln) other than cerium, titanium and tin, it being possible, of course, for these elements to be present as a mixture, as will be seen in the continuation of the description.

Another characteristic of the dispersion of the invention is the presence of cerium in the form of cerium(III). The amount of cerium(III) expressed by the cerium(III)/total cerium atomic ratio, is between 0.005 and 0.06. More particularly, this amount can be between 0.005 and 0.05 and more particularly still between 0.005 and 0.03.

It should be noted here that cerium(III) can be present in the compound as cation, either in the form adsorbed at the surface of the particles of the cerium compound or in the crystal unit cell of the compound. Of course, both these forms may coexist.

The presence of cerium(III) in solution can be demonstrated by chemical quantitative determination. Use may thus be made of a technique for analysis by potentiometric assaying by oxidation of cerium(III) to give cerium(IV) using potassium ferricyanide in potassium carbonate medium. The presence of cerium(III) at the surface of the particles can be demonstrated by the determination of the isoelectric point of the colloidal dispersions. This determination is carried out in a known way by measuring the variation in the zeta potential of the dispersions. When the variation in this potential is measured, by varying the pH of a dispersion from an acidic value to a basic value, this potential changes from a positive value to a negative value, the transition at the zero value of the potential constituting the isoelectric point. The presence of cerium(III) at the surface increases the value of the isoelectric point with respect to a compound comprising only cerium(IV).

Various alternative forms of the invention, depending on the nature of the cerium compound and more specifically on the nature of the element M, will now be described in more detail. It should be noted here that the formulae which are given below in the description of these alternative forms correspond to compositions which result from chemical analyses on colloids recovered either by ultracentrifuging at 50 000 rev/min for 6 hours or after washing the dispersions, this washing being carried out by ultra-filtration or by dialysis with at least 10 equivalent volumes of water (1 volume of dispersion:10 volumes of water).

According to a first alternative form, the element M is zirconium. More particularly, in the case of this alternative form, the compound can correspond to the formula (1) Ce₁₋ₓZrₓO₂ in which x is less than 1 and is at least equal to 0.01, preferably at least equal to 0.02.

According to another alternative form, the element M is a combination of zirconium and of tin. More particularly, in the case of this alternative form, the compound can correspond to the following formula (2) Ce_{1-y}ZrₓSn_{y}O₂ in which x+y<1, x confirms the condition 0.05≦x≦0.95 and y is at least equal to 0.01, the high value of y being chosen so that a solid solution is indeed obtained. Preferably, x confirms the condition 0.20≦x≦0.8 and more preferably still the condition 0.40≦x≦0.60. Preferably also, y is at least equal to 0.05 and more preferably still y is at least equal to 0.2. Preferably, y is at most equal to 0.4 and more preferably still at most equal to 0.25.

According to a third alternative form, the element M is a combination of zirconium and of at least one rare earth metal Ln. The invention applies very particularly well to the case where the rare earth metal is a trivalent rare earth metal. The rare earth metal can be in particular lanthanum, gadolinium, terbium, praseodymium or neodymium. More particularly in the case of this third alternative form, the compound can correspond to the formula (3) Ce_{1-x-y}ZrₓLn_{y}O₂ in which x+y<1, x confirms the condition 0.05≦x≦0.95 and y is at least equal to 0.01, the high value of y being chosen so that a solid solution is indeed obtained. Preferably, x confirms the condition 0.20≦x≦0.08 and more preferably still the condition 0.40≦x≦0.60. Preferably also, y is at least equal to 0.02 and more preferably still y is at least equal to 0.04. Preferably, y is at most equal to 0.05 and more preferably still at most equal to 0.03. Still in the case of this alternative form, the element M can be a combination of at least two rare earth metals, at least one of which is praseodymium. Finally, it may be noted that, in the case where M is terbium or praseodymium, optionally in combination with another rare earth metal, these elements can be present both in the Tb(III) and Pr(III) forms and the Tb(IV) and Pr(IV) forms.

According to yet another alternative form, the element M is a combination of zirconium, of tin and of at least one rare earth metal Ln. Here again, the invention applies very particularly well to the case where the rare earth metal is a trivalent rare earth metal, and the rare earth metal can in particular be lanthanum, gadolinium, terbium, praseodymium or neodymium. More particularly in the case of this alternative form, the compound can correspond to the formula (4) Ce_{1-x-y-z}ZrₓSn_{y}Ln_{z}O₂ in which x+y+z<1, x confirms the condition 0.05≦x≦0.95, y is at least equal to 0.01 and z is at least equal to 0.01. Preferably, x confirms the condition 0.20≦x≦0.8 and y is at least equal to 0.10 and more preferably still x confirms the condition 0.40≦x≦0.60 and y is at least equal to 0.2. The high values of y and z are chosen so that a solid solution is indeed obtained. Preferably, y is at most equal to 0.4 and more preferably still at most equal to 0.25; furthermore, preferably, z is at most equal to 0.05 and more preferably still at most equal to 0.03.

The compound of the dispersion of the invention can also be a compound in which M is a rare earth metal or a combination of rare earth metals. Again, the invention applies very particularly well to the case where the rare earth metal is a trivalent rare earth metal. The rare earth metal can in particular be lanthanum, gadolinium, terbium, praseodymium or neodymium. The compound can then correspond more particularly to the following formula (5) Ce₁₋ₓLnₓO₂ in which x is at most equal to 0.15 and is at least equal to 0.01, preferably at least equal to 0.02 and more preferably still at least equal to 0.04. Preferably, x is at most equal to 0.10 and more preferably still at most equal to 0.05. The rare earth metal can be present, at least in part, in the Ln(III) form and, here again, either in the crystal unit cell or in the form adsorbed at the surface of the particles of the cerium compound. In the case of praseodymium, the latter element can be present both in the Pr(III) and Pr(IV) forms and, in the same case, x is more particularly at least equal to 0.04 and more particularly still between 0.03 and 0.08.

According to yet another alternative form of the invention, the compound is a mixed oxide of formula (6) Ce₁₋ₓTiₓO₂ in which x is at most equal to 0.6 and is at least equal to 0.01, preferably at least equal to 0.05 and more preferably still at least equal to 0.2. Preferably, x is at most equal to 0.5.

The particles which constitute the compound of the dispersion exhibit a fine and narrow particle size distribution. This is because they have a size, measured by their mean diameter, which is preferably at most 10 nm and which can more particularly be between 2 and 8 nm. This size is conventionally determined by transmission electron microscopy (TEM) on a sample dried beforehand on a carbon membrane supported on a copper grid and over a mean of 50 measurements.

In addition, these particles are well separated. The cryo-TEM technique can be used to determine the state of aggregation of the particles. It makes it possible to observe, by transmission electron microscopy, samples kept frozen in their natural medium, which can, for example, be water.

Freezing is carried out on thin films with a thickness of approximately 50 to 100 nm in liquid ethane for aqueous samples.

The state of dispersion of the particles is well preserved by cryo-TEM and representative of that present in the true medium. In the present case, cryo-TEM demonstrates the well-separated appearance of the particles.

The dispersion of the invention generally exhibits a pH which can be between 0.5 and 6.

The dispersion of the invention generally exhibits a concentration of mixed oxide of at least 0.1 M, preferably of at least 0.25 M and advantageously of greater than 1 M.

Other specific embodiments of the dispersion of the invention will now be described.

A specific form corresponds to dispersions having a basic pH. According to this form, the compound of cerium and of at least one other element M exists in the form of particles additionally comprising citrate anions, these anions being adsorbed at the surface of the particles. The molar ratio r=citric acid/mixed oxide is generally between 0.1 and 0.6, preferably between 0.2 and 0.45. For this embodiment, the pH of the dispersions is at least 7, preferably at least 8.

Another specific embodiment corresponds to dispersions which are functionalized. In this case, the compound of cerium and of at least one other element M exists in the form of particles comprising, at the surface, a bifunctional compound comprising a functional group R₁ of amine, sulfate, phenyl, alkylethoxy or succinate type and a functional group R₂ of carboxylic, dicarboxylic, phosphoric, phosphonic or sulfonic type, the functional groups R₁ and R₂ being separated by an organic chain of the —(CH₂)ₓ— type, x preferably being at most equal to 6. It may be thought that this bifunctional compound is bonded at the surface by interactions of complexing type between the functional group R₂ and the cerium or M present at the surface of the colloidal particles. The molar ratio r′=bifunctional compound/mixed oxide is generally at most 0.6, preferably at most 0.4 and more preferably still at most 0.2.

The bifunctional compound can be chosen from aliphatic amino acids, for example aminocaproic acid, aminated sulfonic acids, such as aminoethylsulfonic acid, or alkyl polyoxyethylene ether phosphates.

Finally, it should be noted that the colloidal dispersions of the invention are particularly stable, that is to say that separation by settling or phase separation is not observed over a period of time which can be greater than 1 year.

The process for the preparation of the dispersions of the invention will now be described.

As indicated above, this process comprises a first stage in which a liquid medium comprising cerium salts and salts of at least one element M is formed, the cerium salts being cerium(IV) and cerium(III) salts.

The proportion of cerium(III) salts and of cerium(IV) salts, expressed by the Ce(III)/total Ce (Ce(III)+Ce(IV)) molar ratio, is generally at least 2% and at most 20%, preferably between 2% and 10%, this proportion being chosen according to the level of cerium(III) desired in the colloidal dispersion which it is desired to prepare. The liquid medium is generally water and the salts are usually introduced in the form of solutions.

The salts can be salts of inorganic or organic acids, for example of the sulfate, nitrate, chloride or acetate type, it being understood that the starting medium must comprise at least one cerium(IV) salt. Use may more particularly be made, as Ce(IV) solution, of a ceric ammonium nitrate solution to which Ce(III) is added in the form of cerous nitrate or Ce(III) acetate or cerous chloride. Use may also be made of a ceric nitrate solution obtained by attack on CeO₂ by nitric acid, Ce(III) being added to this solution. Use may advantageously be made of a ceric nitrate solution obtained by electrolysis and comprising Ce(III). The solution of Ti(IV) can be of TiOCl₂. The solution of Zr(IV) can be of ZrOCl₂ or of ZrO(NO₃)₂. Use may be made, as tin salts, of SnCl₄.5H₂O. The rare earth metals Ln are generally introduced in the form of salts Ln(III) for example by nitrates.

The second stage of the process consists in bringing the medium formed above into contact with a base.

Use may in particular be made, as base, of products of the hydroxide type. Mention may be made of alkali metal hydroxides, alkaline earth metal hydroxides and aqueous ammonia. Use may also be made of secondary, tertiary or quaternary amines. However, the amines and ammonia may be preferred insofar as they reduce risks of contamination by alkali metal or alkaline earth metal cations.

The addition of the base is carried out instantaneously or gradually but so as to obtain a pH of the medium of at least 9, preferably of at least 9.5 and more preferably still of at least 10. The addition of the base results in the formation of a precipitate.

After the addition of the base, it is possible to carry out a maturing of the medium for a period of time which can vary, for example, between 10 minutes and 1 hour, generally at ambient temperature.

The precipitate can be separated from the liquid medium by any known process, for example by centrifuging.

The precipitate resulting from the reaction can subsequently be washed. This washing can be carried out by putting the precipitate back into water and then, after stirring, by separating the solid from the liquid medium, for example by centrifuging. This operation can be repeated several times, if necessary. Generally, this washing is carried out so as to obtain a washing slurry, that is to say the water in which the precipitate is resuspended, with a pH of at most 8.75, preferably at most 8, advantageously of at most 7.

The final stage of the process is a stage of peptization of the precipitate obtained above. This peptization is carried out by treatment of the precipitate with an acid. This treatment is generally carried out by dispersing the precipitate in an acidic solution and stirring the medium thus formed. Use may be made, for example, of nitric acid, hydrochloric acid or acetic acid. The acetic acid can advantageously be used to obtain dispersions of compounds in which the content of trivalent rare earth metal is high. The peptization is generally carried out at a temperature between ambient temperature and 90° C., preferably at ambient temperature. The amount of acid used is such that the H⁺/(Ce+M) molar ratio is generally at most 1.5, preferably at most 1.25 and more preferably still at most 1. On conclusion of the peptization, a colloidal dispersion according to the invention is obtained directly and without another intermediate stage.

It is possible to wash, by ultrafiltration or by dialysis, the dispersion thus obtained. This washing makes it possible to remove the element M which might be in ionic form.

It should be noted that the process of the invention comprises at least one washing stage, it being possible for this washing to take place under the conditions which have just been described, that is to say either on the precipitate or on the dispersion or also on both.

For the specific embodiment described above in which the particles comprise citrate anions at the surface, the preparation process is of the type of that which has just been described but it is supplemented by a stage of bringing into contact the citric acid. More specifically, the citric acid can be added to the dispersion obtained after peptization, for example in the form of a citric acid hydrate powder. The citric acid then dissolves with stirring. The citric acid/mixed oxide molar ratio is within the range of values given above, that is to say generally between 0.1 and 0.6. It is possible to leave the medium obtained standing for between 30 minutes and 24 hours at ambient temperature.

Subsequently, a solution of a base is gradually added, this base being of the same type as that described above for the precipitation stage, so as to obtain the desired pH of at least 7, preferably of at least 8. More specifically, the addition can be carried out between 10 min and 2 hours at ambient temperature.

Likewise, in order to obtain a functionalized dispersion according to the embodiment described above, the bifunctional compound is added to the dispersion obtained after peptization.

The invention also relates to a dispersible solid, that is to say a solid capable of resulting in a colloidal dispersion according to the invention.

This solid exists in the form of a powder or of a paste. It is based on a compound of cerium and at least one other element M chosen from zirconium, rare earth metals (Ln) other than cerium, titanium and tin, this compound being in the form of a mixed oxide in which the cerium and the element M are in solid solution. Everything said above relating to the compound in the mixed oxide form also applies here. In the case of the specific embodiments described above, the particles which constitute the solid comprise, at the surface, in complex form, the citrate anion or the bifunctional compound.

The solid can be obtained by simple evaporation of the water from the dispersion under mild conditions, that is to say at a temperature of at most 80° C.

The solid exhibits the property of being redispersible, that is to say of being able to give a colloidal dispersion according to the invention and as described above when it is suspended in a liquid phase, in particular in water.

The dispersions of the invention can be used in numerous applications. Mention may be made of catalysis, in particular for automobile afterburning; in this case, the dispersions are used in the preparation of catalysts. The dispersions can also be employed for lubrication, in ceramics or the manufacture of pigments; this is the case in particular with dispersions in which the compound is a mixed oxide of cerium and of praseodymium and which exhibit a red color. The dispersions can also be employed for their UV-inhibiting properties, for example in the preparation of films of polymers (of the acrylic or polycarbonate type, for example) or of cosmetic compositions, in particular in the preparation of creams for protecting from UV radiation. The dispersions based on a mixed oxide of cerium and of gadolinium can be used in the preparation of materials for fuel cells. Finally, they can be used on a substrate as corrosion inhibitors.

Examples will now be given.

### EXAMPLE 1

This example relates to the preparation of a colloidal dispersion of particles of formula Ce_{0.78}Ti_{0.22}O₂.

35 ml of ceric nitrate solution, obtained by electrolytic oxidation of a Ce³⁺ solution, having a concentration of Ce⁴⁺ of 1.425M (i.e., 50 mmol of Ce⁴), of Ce³⁺ of 0.11M and of HNO₃ of 0.7M, are added to 2.7 ml of TiOCl₂ solution with a Ti⁴⁺ concentration of 4.6M (12.5 mmol of Ti⁴⁺). The volume is made up to 500 ml. The pH is 1.3.

40 ml of 28% NH₃ solution are instantaneously added. The pH is 10.

The precipitate formed is filtered off and washed with 4 times 1 liter of deionized water. The pH of the slurry is 7.5.

This operation is repeated twice (i.e., three operations in total).

The precipitate is resuspended in a solution comprising 7.2 g of 68% HNO₃ (H⁺/Ce+Ti)=1.25 in moles) and the volume is made up to 100 ml. The Ce+Zr concentration is equal to 0.625M. The mixture is left stirring overnight. A colloidal dispersion is obtained which is clear to the eye.

The characteristics of the dispersion obtained are given below.

The dispersion is washed by dialysis using dialysis membranes. 80 ml of the colloidal dispersion are poured into a dialysis bag and dialysis is carried out in a 500 ml cylinder filled with deionized water. Dialysis is allowed to take place for 24 hours and the water is replaced 5 times.

A Ce(III)/total Ce atomic ratio of 0.05 is determined by chemical analysis on the washed colloidal dispersion.

The size of the colloids, determined by TEM on the colloidal dispersion thus washed, is 4 nm.

An X-ray diffraction analysis is carried out on dried colloids obtained by evaporating the dialyzed colloidal dispersion at 50° C. The diffraction diagram, which is given in FIG. 1, exhibits the lines characteristic of a single crystalline phase and shows a slight line displacement (unit cell parameter a=5.393+/−0.001 Å) in comparison with a diffraction diagram produced on dried CeO₂ colloids prepared according to the same procedure but without addition of Ti (unit cell parameter a=5.41 Å), thus demonstrating the solid solution characteristic of the particles.

### EXAMPLE 2

This example relates to the preparation of a colloidal dispersion of particles of formula Ce_{0.94}Pr_{0.06}O₂.

8.5 ml of Pr(NO₃)₃ solution with a Pr³⁺ concentration of 2.95M (25 mmol of Pr³⁺) are added to 70 ml of ceric nitrate Ce(NO₃)₄ solution, obtained by electrolytic oxidation of a Ce³⁺ solution, having a Ce⁴⁺ concentration of 1.425M (i.e., 100 mmol of Ce⁴⁺), of Ce³⁺ of 0.11M and of HNO₃ of 0.7M, and the volume is made up to 1000 ml. The pH is 1.3. 80 ml of 28% NH₃ solution are added instantaneously; the pH is 10.

The precipitate is washed on a sintered glass funnel with 4 times 1 liter of deionized water. The pH of the slurry is 7.5.

After filtration, the product is resuspended with a solution comprising 11.6 g of 68% nitric acid (125 mmol of H⁺) and the volume is made up to 250 ml. The H⁺/(Ce+Pr) molar ratio is equal to 1. The pH is 1.1. The Ce+Pr concentration is equal to 0.5M. The mixture is left stirring overnight.

The colloidal dispersion is washed by dialysis as in example 1.

The colloidal dispersion is clear to the eye and red.

A Ce(III)/total Ce atomic ratio of 0.03 is determined by chemical analysis on the washed colloidal dispersion.

The size of the colloids, determined by TEM, is 4 nm.

An X-ray diffraction analysis is carried out on dried colloids obtained by evaporating the dialyzed colloidal dispersion at 50° C. The diffraction diagram exhibits the lines characteristic of a single crystalline phase with a unit cell parameter (a 5.41 Å) corresponding to that of pure CeO₂. No line displacement is thus observed by X-ray diffraction, this being due to the low concentration of Pr³⁺ doping agent. Nevertheless, the red coloration of the colloids suggests the formation of a solid solution with insertion of Pr⁴⁺ ions within the fluorite structure of the CeO₂.

### EXAMPLE 3

This example relates to the preparation of a colloidal dispersion of particles of formula Ce_{0.53}Zr_{0.46}O₂.

44 ml of ceric nitrate solution, obtained by electrolytic oxidation of a Ce³⁺ solution, having a concentration of Ce⁴⁺ of 1.425M (i.e., 62.5 mmol of Ce⁴⁺), of Ce³⁺ of 0.11M and of HNO₃ of 0.7M, are added to 19 ml of ZrO(NO₃)₂ solution having a Zr⁴⁺ concentration of 3.32M (62.5 mmol of Zr⁴⁺). The volume is made up to 1000 ml. The pH is 1.06.

80 ml of 28% NH₃ solution are instantaneously added. The pH is 10.

The precipitate formed is filtered off and washed with 1 liter of deionized water, 4 times in succession. The pH of the slurry is 7.5.

This operation is repeated twice (i.e., three operations in total).

The precipitate is resuspended in a solution comprising 26.1 g of 68% HNO₃ (H⁺/Ce⁺ Zr=0.75 in moles) and the volume is made up to 600 ml. The Ce⁺ Zr concentration is equal to. 0.625M. The mixture is left stirring overnight. A colloidal dispersion which is clear to the eye is obtained.

The characteristics of the dispersion obtained are given below.

The colloidal dispersion is then washed by dialysis, as in example 1.

The size of the colloids, determined by TEM on the colloidal dispersion thus washed, is 4 nm.

A Ce³⁺/Ceₜₒₜₐₗ ratio of 0.007 and a chemical composition Ce_{0.53}Zr_{0.46}O₂ are determined by chemical analysis on the washed dispersion.

By electrophoretic measurements, an isoelectric point equal to pH 9 is determined, characteristic of the presence of Ce³⁺ at the surface of the colloidal particles.

An X-ray diffraction analysis is carried out on dried colloids obtained by evaporating the dialyzed colloidal dispersion at 50° C. The diffraction diagram, which is given in FIG. 2, exhibits the lines characteristic of a single crystalline phase of (Ce,Zr)O₂ type and shows a slight line displacement (unit cell parameter a=5.349 Å) in comparison with a diffraction diagram produced on dried CeO₂ colloids prepared according to the same procedure but without addition of Zr, thus demonstrating the solid solution characteristic of the particles.

### EXAMPLE 4

This example relates to the preparation of a colloidal dispersion of particles of formula Ce_{0.38}Zr_{0.37}Sn_{0.24}O₂.

35 ml of ceric nitrate solution, obtained by electrolytic oxidation of a Ce³⁺ solution, having a concentration of Ce⁴⁺ of 1.425M (i.e., 50 mmol of Ce⁴⁺), of Ce³⁺ of 0.11M and of HNO₃ of 0.7M, are added to 15 ml of ZrO(NO₃)₂ solution having a concentration of Zr⁴ of 3.32M (50 mmol of Zr⁴⁺). 8.8 g of SnCl₄.5H₂O (i.e., 25 mmol of Sn) are dissolved with stirring in the mixed solution of cerium and zirconium nitrate. The volume is made up to 1000 ml. The pH is 1.2.

80 ml of 28% NH₃ solution are instantaneously added. The pH is 10.

The precipitate formed is filtered off and washed with 1 liter of deionized water, 4 times in succession. The pH of the slurry is 7.4.

The precipitate is resuspended in a solution comprising 8.7 g of 68% HNO₃ (H⁺/Ce⁺ Zr=0.75 in moles) and the volume is made up to 200 ml. The Ce⁺ Zr concentration is equal to 0.625M. The mixture is left stirring overnight. A colloidal dispersion which is clear to the eye is obtained.

The dispersion is washed by dialysis, as in example 1. The size of the colloids, determined by TEM on the colloidal dispersion thus washed, is 4 nm.

A Ce³⁺/Ceₜₒₜₐₗ ratio of 0.0064 and a chemical composition Ce_{0.38}Zr_{0.37}Sn_{0.24}O₂ are determined by chemical analysis on the washed dispersion

An X-ray diffraction analysis is carried out on dried colloids obtained by evaporating the dialyzed colloidal dispersion at 50° C. The diffraction diagram exhibits the lines characteristic of a single crystalline phase of (Ce,Zr)O₂ type and shows a slight line displacement (unit cell parameter a=5.349 Å) in comparison with a diffraction diagram produced on dried CeO₂ colloids prepared according to the same procedure but without addition of Zr and Sn, demonstrating the solid solution characteristic of the particles.

### EXAMPLE 5

This example relates to the preparation of a colloidal dispersion of particles of formula Ce_{0.53}Zr_{0.46}O₂ at basic pH.

6.9 g of citric acid monohydrate (Mw=210 g) are added to 200 cm³ of a nondialyzed colloidal dispersion prepared as in example 3 above and diluted to a Ce_{0.53}Zr_{0.46}O₂ concentration of 60 g/l; the citrate/Ce_{0.53}Zr_{0.46}O₂ molar ratio is approximately 0.4. The mixture is left stirring for 60 minutes. After 60 minutes, 9 ml of an approximately 20% NH₃ solution are gradually added over 15 min.

A colloidal dispersion with a pH of 8.5 is obtained after stirring overnight.

### EXAMPLE 6

The dispersion of example 5 with a pH of 8.5, obtained by addition of citrate, is evaporated at 45° C. A powder is obtained which is redispersible by addition of water.

### EXAMPLE 7

This example relates to the preparation of a colloidal dispersion of particles of formula Ce_{0.9}Gd_{0.1}O₂.

21 ml of Gd(NO₃)₃ solution with a Gd³⁺ concentration of 2.35M (50 mmol of Gd³⁺) are added to 140 ml of ceric nitrate Ce(NO₃)₄ solution, obtained by electrolytic oxidation of a Ce³⁺ solution and having a concentration of Ce⁴⁺ of 1.425M (i.e., 200 mmol of Ce⁴⁺), of Ce³⁺ of 0.11M and of HNO₃ of 0.7M, and the volume is made up to 2000 ml. The pH is 1.2. 160 ml of 28% NH₃ solution are instantaneously added. The pH is then 10.

The precipitate is washed on a sintered glass funnel with 4 times 1 liter of deionized water. The pH of the slurry is 7.2.

After filtration, the product is resuspended with a solution comprising 15 g of 100% acetic acid, with a density of 1.05 (262 mmol), and the volume is made up to 500 ml. The acetic acid/(Ce⁺ Gd) molar ratio is 1.00. The mixture is left stirring overnight.

The colloidal dispersion obtained is subsequently washed by dialysis. 80 ml of the colloidal dispersion are poured into a dialysis bag and dialysis is carried out in a 500 ml cylinder filled with deionized water.

Dialysis is allowed to take place for 24 hours and the water is replaced 5 times. The pH is 5.

The colloidal dispersion is clear to the eye, the size of the colloids is 4 nm and the chemical composition, determined by quantitative determination, is Ce_{0.9}Gd_{0.1}O₂. The diffraction diagram exhibits the lines characteristic of a single crystalline phase with a unit cell parameter a=5.41 Å, identical to that of pure CeO₂, due to the very low concentration of doping agent incorporated.

### EXAMPLE 8

This example relates to the preparation of a colloidal dispersion of particles of formula Ce_{0.15}Zr_{0.83}La_{0.02}O₂.

6.6 ml of ceric nitrate solution, obtained by electrolytic oxidation of a Ce³⁺ solution, having a concentration of Ce⁴⁺ of 1.425M (i.e., 9.4 mmol of Ce⁴⁺), of Ce³⁺ of 0.11M and of HNO₃ of 0.7M, are added to 15 ml of ZrO(NO₃)₂ solution having a Zr⁴⁺ concentration of 3.32M (50 mmol of Zr⁴⁺). 4.5 ml of La(NO₃)₃ solution having an La³⁺ concentration of 2.785M (12.5 mmol of La³⁺) are subsequently added. The volume is made up to 500 ml with demineralized water. The pH is 1.3.

40 ml of 28% NH₃ solution are instantaneously added. The pH is 10.

The precipitate formed is filtered off and washed with 1 liter of deionized water, 4 times in succession. The pH of the slurry is 7.5.

The precipitate is resuspended in a solution comprising 7.2 g of 68% HNO₃ (H⁺/(Ce+Zr+La)=1.08 in moles) and the volume is made up to 100 ml. The mixture is left stirring overnight. A colloidal dispersion which is clear to the eye is obtained.

The dispersion is washed by dialysis as in example 1. The size of the colloids, determined by TEM on the colloidal dispersion thus washed, is 4 nm.

An X-ray diffraction analysis is carried out on dried colloids obtained by evaporating the dialyzed colloidal dispersion at 50° C. The diffraction diagram exhibits the lines characteristic of a single crystalline phase of solid solution type.

1-19. (canceled)

20. A colloidal dispersion, in a continuous phase, of a compound of cerium and at least one other element M selected from the group consisting of zirconium, rare earth metals (Ln) other than cerium, titanium and tin, wherein the compound is in the form of a mixed oxide in which the cerium and the element M are in pure solid solution and in that the compound comprises cerium in the form of cerium(III) in an amount, expressed as cerium(III)/total cerium atomic ratio, ranging from 0.005 to 0.06.

21. The colloidal dispersion as defined by claim 20, wherein the element M is zirconium, a combination of zirconium and of tin, a combination of zirconium and of at least one rare earth metal Ln or a combination of zirconium, of tin and of at least one rare earth metal Ln.

22. The colloidal dispersion as defined by claim 21, wherein the compound is at least partially in the form of a mixed oxide of formula Ce₁₋ₓZrₓO₂ in which x is less than 1 and is at least equal to 0.01.

23. The colloidal dispersion as defined by claim 21, wherein the compound is at least partially in the form of a mixed oxide of formula Ce_{1-x-y}ZrₓSn_{y}O₂ in which x+y<1, x satisfies the condition 0.05≦x≦0.95 and y is at least equal to 0.01.

24. The colloidal dispersion as defined by claim 21, wherein the compound is at least partially in the form of a mixed oxide of formula Ce_{1-x-y}ZrₓLn_{y}O₂, in which x+y<1, x satisfies the condition 0.05≦x≦0.095 and y is at least equal to 0.01.

25. The colloidal dispersion as defined by claim 21, wherein the compound is at least partially in the form of a mixed oxide of formula Ce_{1-x-y-z-}ZrₓSn_{y}Ln_{z}O₂ in which x+y+z<1, x satisfies the condition 0.05≦x≦0.095, y is at least equal to 0.01, and z is at least equal to 0.01.

26. The colloidal dispersion as defined by claim 20, wherein the element M is a rare earth metal Ln, or a combination of rare earth metals and the compound is at least partially in the form of a mixed oxide of formula Ce₁₋ₓLnₓO₂ in which x is at most equal to 0.15 and is at least equal to 0.01.

27. The colloidal dispersion as defined by claim 20, wherein the element M is titanium and the compound is at least partially in the form of a mixed oxide of formula Ce₁₋ₓTiₓO₂ in which x is at most equal to 0.6 and is at least equal to 0.01.

28. The colloidal dispersion as defined by claim 24, wherein the rare earth metal Ln is praseodymium.

29. The colloidal dispersion as defined by claim 20, comprising cerium(III) in an amount ranging from 0.005 to 0.05.

30. The colloidal dispersion as defined by claim 20, wherein the compound of cerium and of at least one other element M exists in the form of particles having a size of at most 10 nm.

31. The colloidal dispersion as defined by claim 20, wherein the compound of cerium and of at least one other element M exists in the form of particles comprising citrate anions at the surface thereof.

32. The colloidal dispersion as defined by claim 20, wherein the compound of cerium and of at least one other element M exists in the form of particles comprising, at the surface thereof, a bifunctional compound which comprises an amine, sulfate, phenyl, alkylethoxy or succinate functional group R₁ and a carboxylic, dicarboxylic, phosphoric, phosphonic or sulfonic, functional group R₂, the functional groups R₁ and R₂ being separated by a —(CH₂)ₓ— radical.

33. The colloidal dispersion as defined by claim 20, wherein the continuous phase is an aqueous phase.

34. A dispersible solid based on a compound of cerium and of at least one other element M selected from the group consisting of zirconium, rare earth metals (Ln) other than cerium, titanium and tin, said compound being in the form of a mixed oxide in which the cerium and the element M are in solid solution, the same being redispersible in an aqueous phase to provide a colloidal dispersion as defined by claim 20.

35. A process for the preparation of a dispersion as defined by claim 20, comprising the following stages:
forming a liquid medium which comprises salts of cerium and of at least one element M, the cerium salts being cerium(IV) and cerium(III) salts;
contacting said medium with a base, to provide a pH of at least 9, whereby a precipitate is obtained;
separating said precipitate from the medium;
washing the precipitate;
peptizing the precipitate by treatment with an acid, whereby the dispersion is obtained; the process additionally comprising at least one washing stage, either after the stage of separating of the precipitate or after the peptization stage.

36. The process as defined by claim 35 for the preparation of a dispersion in which the compound of cerium and of at least one other element M exists in the form of particles comprising citrate anions at the surface thereof, wherein citric acid is added to the dispersion obtained after peptization by the acid.

37. The process for the preparation of a dispersible solid as defined by claim 34, comprising the following stages:
forming a liquid medium which comprises salts of cerium and of at least one element M, the cerium salts being cerium(IV) and cerium(III) salts;
contacting the medium with a base, to provide a pH of at least 9, whereby a precipitate is obtained;
separating said precipitate from the medium;
washing the precipitate;
peptizing the precipitate by treatment with an acid, whereby a dispersion is obtained;
evaporating the dispersion obtained after peptization by the acid; the process additionally comprising at least one washing stage, either after the stage of separating of the precipitate or after the peptization stage.

38. The process as defined by claim 35, wherein the precipitate is peptized by treatment with nitric acid, hydrochloric acid or acetic acid.

39. The colloidal dispersion as defined by claim 21, wherein Ln comprises a trivalent rare earth metal.
